(19) United States
(12) Patent Application Publication
(10) Pub. No.: US 2003/0071531 A1
(43) Pub. Date: Apr. 17, 2003

(54) Electric energy-conversion machines with stator windings encircling the rotor

(76) Inventor: Dominic V. DeCesare, Elizabeth, NJ (US)

Correspondence Address: MR. VITO DECESARE, 220 WEST JERSEY STREET, ELIZABETH, NJ, 07202, US

(21) Appl. No.: 09/981,938

(22) Filed: Oct. 17, 2001

(51) Int. Cl. H02K 1/00; H02K 3/00

(52) U.S. Cl. 310/181

(57) ABSTRACT

A design for a motor, alternator, generator, or the like wherein the stator element that provides the magnetic field passing through the rotor completely encircles the rotor above and below its longitudinal axis. This stator element may be a permanent magnet or an electromagnet. This stator design can be combined with a conventional stator element that also provides a magnetic field. In such case, at least one of the magnetic field producing elements of the stator is a permanent magnet.

### FIELD OF THE INVENTION

This invention relates generally to energy-conversion and, more particularly, to devices such as motors, generators and alternators and the like which provide a mechanical output in response to electrical energy and vice versa.

### BACKGROUND OF THE INVENTION

For purposes of this disclosure, the term electric energy-conversion machine means a machine or device having magnetic field generating components and which converts a non-electrical energy input into an electric energy output and vice versa. The operation of an electric energy-conversion machine, such as a motor, alternator, or generator, relies upon effective coupling of magnetic flux or field developed in the stator poles into the rotor air gap or space and, hence, the rotor. However, in most electric energy-conversion machines, there is considerable fringe or leakage flux which bypasses the rotor space, and, therefore, is not coupled to the rotor since the magnetic flux takes the path of least resistance in the magnetic circuit, or the path of lowest magnetic reluctance. Since the opposing poles in a two pole electric energy-conversion machine are in the shape of circular cylindrical surfaces, to accommodate the cylindrical rotor, the extreme portions of the opposing poles, which are the closest to each other, offer the path of least resistance to the magnetic flux and a significant portion of that flux bridges such portions of the opposing poles and, thereby, bypasses the rotor. This fringe or leakage flux serves no useful purpose and prevents the electric energy-conversion machine from achieving optimum operational or performance characteristics.

In U.S. Pat. No. 4,942,323, issued on Jul. 17, 1990, an electric motor is disclosed having a stator that uses two electromagnetic elements. The first electromagnetic element includes windings of a conventional design while the second electromagnetic element includes windings that encircle the rotor. While this construction provides a number of performance benefits, the increased weight and manufacturing complexity is unsuitable for certain applications.

### SUMMARY OF THE INVENTION

The shortcomings of the prior art are addressed by the present invention. In accordance with one aspect of the present invention, a motor, generator, alternator or the like uses a stator whose magnetic field generating element encircles the rotor and is disposed above and below the longitudinal axis of the rotor. This magnetic field generating element may be either an electromagnet or a permanent magnet. The resulting structure provides a motor, generator or alternator having significantly reduced weight.

In accordance with another aspect of the present invention, the use of a stator whose magnet field generating element encircles the rotor above and below its longitudinal axis may be combined with a conventional stator magnetic field generating element. In this combination, at least one of the stator elements that provide a magnetic field is a permanent magnet.

### BRIEF DESCRIPTION OF THE DRAWINGS

The present invention will be more fully appreciated from a consideration of the following Detailed Description, which should be read in light of the accompanying drawings in which:

FIG. 1 shows a perspective view of a motor having a rotor with a single rotor winding and two commutator segments, and a stator including only two stator windings in accordance with the principle of the invention;

FIG. 2 shows a perspective view of a motor having a rotor with multiple rotor windings and commutator segments, and a stator including only two stator windings in accordance with the principle of the invention;

FIG. 3 shows a DC motor having a pair permanent magnets in the stator and those components from FIG. 2 in accordance with the principle of invention; and

FIG. 4 shows a DC motor according to the principle, in which the stator has only two field windings and two supplemental windings, and the motor has multiple windings with commutator segments.

### DETAILED DESCRIPTION

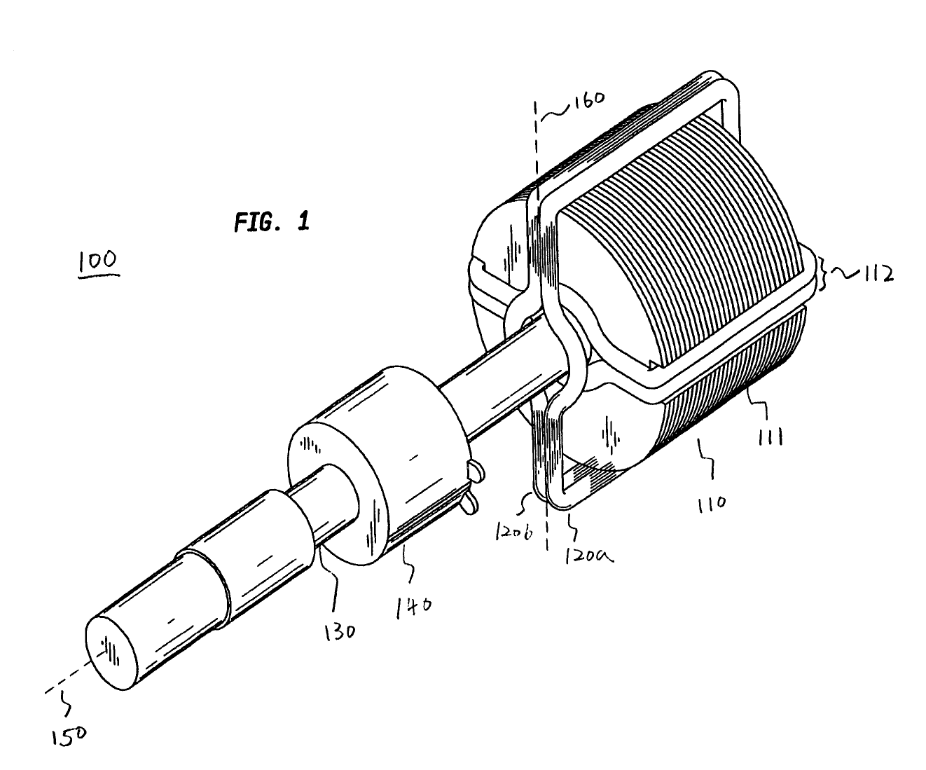

FIG. 1 shows a perspective view of exemplary motor assembly 100 having rotor 110, and a stator including only two stator windings, 120a and 120b, which encircle rotor 110 in accordance with the principles of the invention. Rotor 110 comprises armature 111 and rotor, rotor winding 112, shaft 130, and commutator 140, which are well known in the art and are not described herein. It should be noted that there are only two commutator segments because there is only one rotor winding.

According to the principles of the invention, stator windings 120a and 120b, encircle rotor 110 above and below the longitudinal axis of rotor 110 (shown as 150 in FIG. 1) of the rotor. These windings are not wound on conventional stator supports or forms to reduce weight and are disposed parallel to longitudinal axis 150. Without the restrictions of the supports or the forms, stator windings 120a and 120b are disposed side by side and opposite to each other with respect to dash line 160 which is perpendicular to and intersects the axis of the rotor. Stator windings 120a and 120b are arranged to avoid shaft 130, so that the rotary motion of rotor 110 is not obstructed. Stator windings 120a and 120b are arranged in such a way that the magnetic fluxes generated by both windings pass through the rotor from the same side, i.e., they are arranged in the same North-South (N-S) orientation. Stator windings 120a and 120b are arranged side by side, so that they are as close to the center of the motor as possible. It should be noted that stator windings 120a and 120b can be converted into a single winding by electrical coupling therebetween. An advantage for converting into one winding is that the magnet field generated is stronger, and, thus, the resulting electric energy-conversion machine utilizing these components is more efficient.

As readily appreciated by a person skilled in the art, the structure of motor assembly 100 can also be used to as DC (direct current) or AC (alternating current) generators or AC motors.

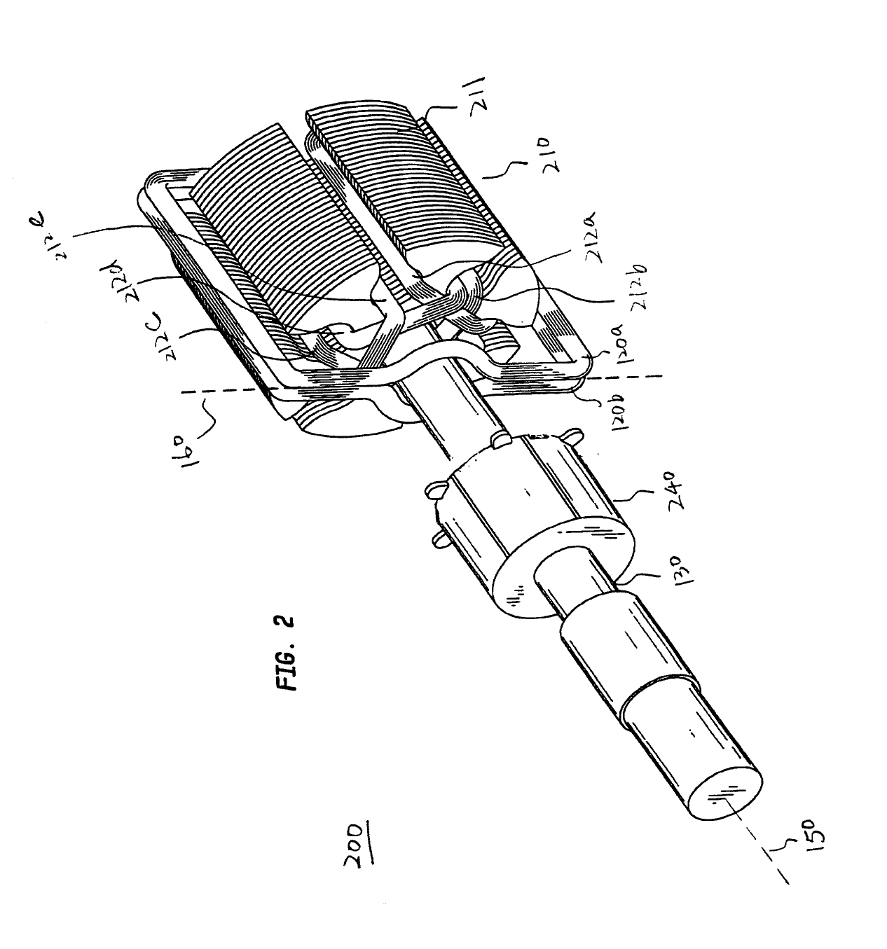

FIG. 2 shows a perspective view of another exemplary motor assembly 200 in which the stator includes only stator windings 120a and 120b. The components that are of the same type as those in FIG. 1 are labeled the same. For example, stator windings 120a and 120b are of the same type as those in FIG. 1. They are disposed in the same manner and can be converted into a single winding as in FIG. 1. Motor assembly 200 is essentially the same as motor assembly 100 except the following two differences. First, rotor 210 has six windings, 212a-212e, rather than just one and, thus, armature 211 has six slots for the six rotor windings. Second, commutator 240 have six commutator segments rather than two. Like motor assembly 100, motor assembly 200 can be used to as DC or AC motors or generators.

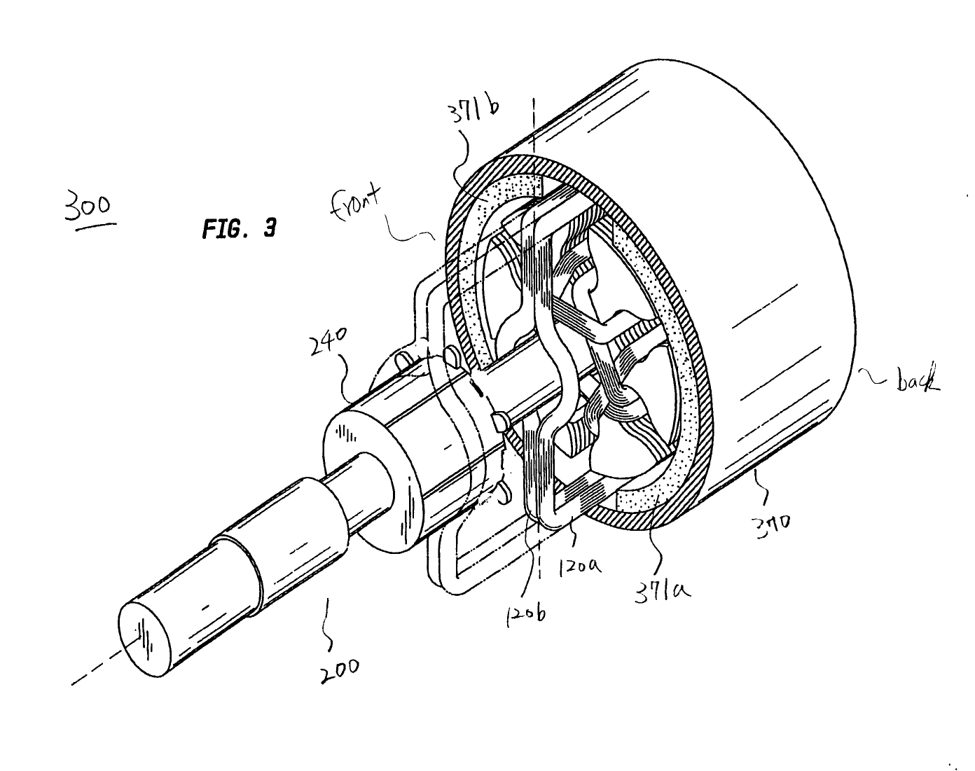

Referring now to FIG. 3, an exemplary DC motor 300 utilizing those components from motor assembly 200 except that stator 370 comprises a pair of permanent magnets, 371a and 371b, in addition to stator windings 120a and 120b. Stator 370 has an air gap for receiving rotor 210 (see FIG. 2 for the components of rotor assembly 200). Rotor 210 is rotatably mounted on stator 370. The assembly of stator 370 and rotor assembly 200 without stator windings 120a and 120b are known in the art and is not described herein. The attachment of stator windings 120a and 120b to stator 370 is by two metal straps (not shown) holding the two stator windings and screwed to the sides of the stator, one on the front side and the other on the back side of stator 370. Other fastening methods can be used as well. For example, stator windings 120a and 120b can be glued to stator 370. As show in FIG. 3, stator windings 120a and 120b (shown in solid lines) are located between commutator 240 and the rotor windings. Optionally, stator windings 120a and 120b (shown in phantom lines) can be shifted further to the left into the area of commutator 240. However, the two stator windings must be shaped in a way (such as shown) as to avoid interfering with the rotary motion of commutators 240. It should be noted that stator windings 120a and 120b can be replaced with a pair of magnets encircling rotor 210 above and below longitudinal axis 150. It should be noted that the magnetic fluxes generated by the stator windings should pass through the motor from the same side as the flux generated by the permanent magnets, so that they do not cancel each other. It should also be noted that the same machine shown in FIG. 3 can be used as a DC generator by converting the rotational mechanical power into DC power output at commutator 240 whose segments are connected to the rotor windings. In a similar manner, the components of motor assembly 100 can be combined with stator 370 to form a DC motor or a DC generator.

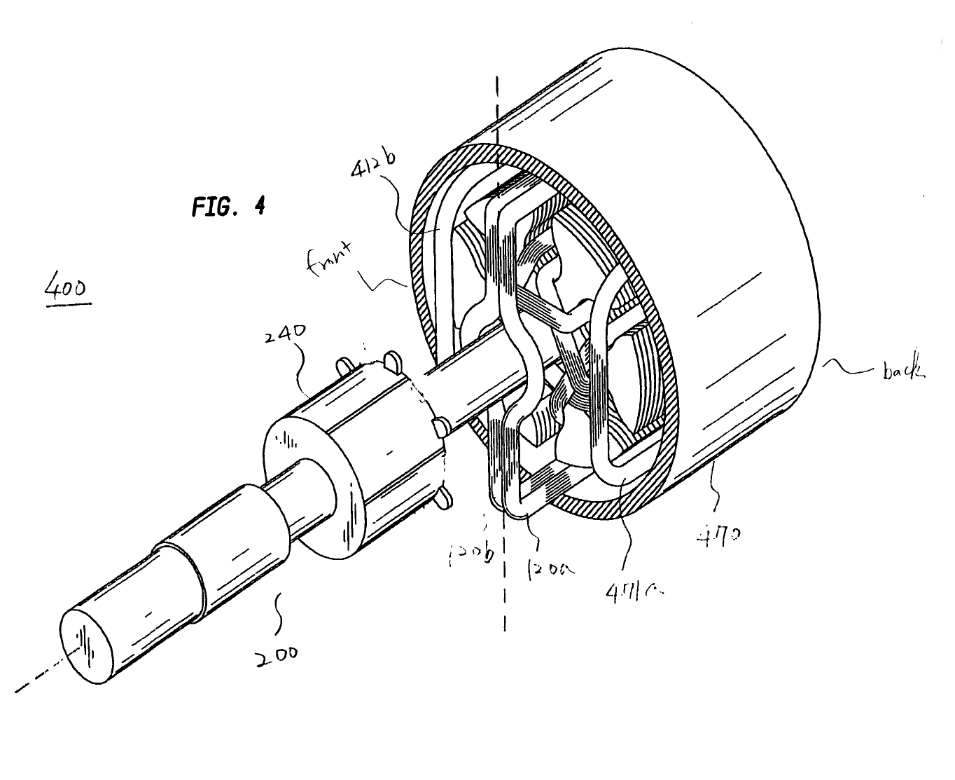

Referring now to FIG. 4, another exemplary DC motor 400 is shown. DC motor 400 comprises the same components as DC motor 300 except that the pair of permanent magnets are replaced by the pair of field windings 471a and 471b in stator 470. The magnet fluxes generated by stator windings 120a and 120b, which can be viewed as supplemental stator windings, should pass through the rotor from the same side as the magnet flux generated by field windings 471a and 471b. In this illustrative embodiment, field windings 471a and 471b are not electrically coupled to stator windings 120a and 120b. However, field windings 471a and 471b can be electrically coupled to stator winding in any conventional fashion, e.g., in series or in parallel. The same electric energy-conversion machine shown in FIG. 4 can be used as an DC generator for converting the rotational mechanical power from rotor assembly into DC power at commutator 240 whose segments are connected to the rotor windings. The same machine can be used as an AC motor if the input power is AC. It can also be used as AC generator if the input power to field windings 471a and 471b is AC.

It should be noted that a motor or a generator comprises other components such as brushes but those components are known in the art and are not described herein.

The examples given herein are presented to enable those skilled in the art to more clearly understand and practice the instant invention. The examples should not be considered as limitations upon the scope of the invention, but as merely being illustrative and representative of the use of the invention. Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention and is not intended to illustrate all possible forms thereof. It is also understood that the words used are words of description, rather than limitation, and that details of the structure may be varied substantially without departing from the spirit of the invention and the exclusive use of all modifications which come within the scope of the appended claims is reserved.

What is claimed is:

1. An electric energy-conversion machine comprising:
a rotor having a longitudinal axis; and
a stator for providing a magnetic field which passes through said rotor, all of the stator which provides said magnetic field encircles said rotor above and below said longitudinal axis.

2. The electric energy-conversion machine of claim 1 wherein the stator includes only a permanent magnet.

3. The electric energy-conversion machine of claim 1 wherein the stator includes a electromagnet.

4. The electric energy conversion machine of claim 1 wherein said rotor includes a commutator.

5. The machine of claim 1 wherein said machine is a motor.

6. The machine of claim 5 wherein said motor is a d.c. motor.

7. The machine of claim 5 wherein said motor is an a.c. motor.

8. The machine of claim 5 wherein said machine is an alternator.

9. The machine of claim 5 wherein said machine is a generator.

10. An electric energy-conversion machine comprising:
a rotor having a longitudinal axis; and
a stator having at least two magnetic field generating elements, wherein at least one of the magnetic field generating elements is a pair of permanent magnets and one of the magnetic field generating elements encircles said rotor above and below said longitudinal axis

11. The electric energy-conversion machine of claim 10 wherein the magnetic field generating elements that encircle the rotor are permanent magnets.

12. The electric energy-conversion machine of claim 10 wherein the magnetic field generating elements which encircle the rotor is a winding.

13. The electric energy-conversion machine of claim 10 wherein said rotor includes a commutator.
